(19) United States
(12) Patent Application Publication
(10) Pub. No.: US 2016/0026461 A1
(43) Pub. Date: Jan. 28, 2016

(54) SYSTEMS AND METHODS FOR AUTOMATIC API DOCUMENTATION

(71) Applicant: GAMESYS LTD, London (GB)

(72) Inventors: Jeffrey Paul Bannister, Herfordshire (GB); Alice Lottini, London (GB)

(73) Assignee: GAMESYS LTD, London (GB)

(21) Appl. No.: 14/775,806

(22) PCT Filed: Mar. 13, 2014
(86) PCT No.: PCT/IB2014/059749

§ 371 Date: Sep. 14, 2015

Related U.S. Application Data
(60) Provisional application No. 61/785,618, filed on Mar. 14, 2013.

(51) Int. Cl. G06F 9/44

(52) U.S. Cl. CPC G06F 8/73

(57) ABSTRACT

Systems, methods, and articles of manufacture provide for automatic API documentation.

### CROSS-REFERENCE TO RELATED APPLICATIONS

This application is a National stage of and claims benefit and priority under to International Application No. PCT/IB2014/059749 filed on Mar. 13, 2014 and titled “SYSTEMS AND METHODS FOR API DOCUMENTATION”, which itself claims benefit and priority to U.S. Provisional Patent Application No. 61/785,618 filed on Mar. 14, 2013 and titled “SYSTEMS AND METHODS FOR API MANAGEMENT”, the entirety of each of which is hereby incorporated by reference herein.

### BACKGROUND

Application Programming Interface (API) objects are used throughout networked computer systems to enhance, simplify, and speed application development and usage. Existing API development processes, however, include inefficiencies that impede API development speed and usage.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a prior art API proxy system;

FIG. 2 is a block diagram of a system according to some embodiments;

FIG. 3 is a flow diagram of a method according to some embodiments;

FIG. 4 is a block diagram of an apparatus according to some embodiments; and

FIG. 5A, FIG. 5B, FIG. 5C, FIG. 5D, and FIG. 5E are perspective diagrams of exemplary data storage devices according to some embodiments.

### DETAILED DESCRIPTION

### I. Introduction

Embodiments presented herein are descriptive of systems, apparatus, methods, and articles of manufacture for automatic API documentation. API management proxies as provided by existing enterprise API management tool vendors, for example, require a user to setup API definitions and their associated documentation on a proxy as two independent steps. This requires the user to enter the same basic information twice. With such existing solutions, the API components on the proxy must be manually created and then the API must be documented using a content management system. In addition to being an inefficiency in the API development process, such existing systems increase the likelihood that the API definition and the separately-developed documentation are not properly synchronized.

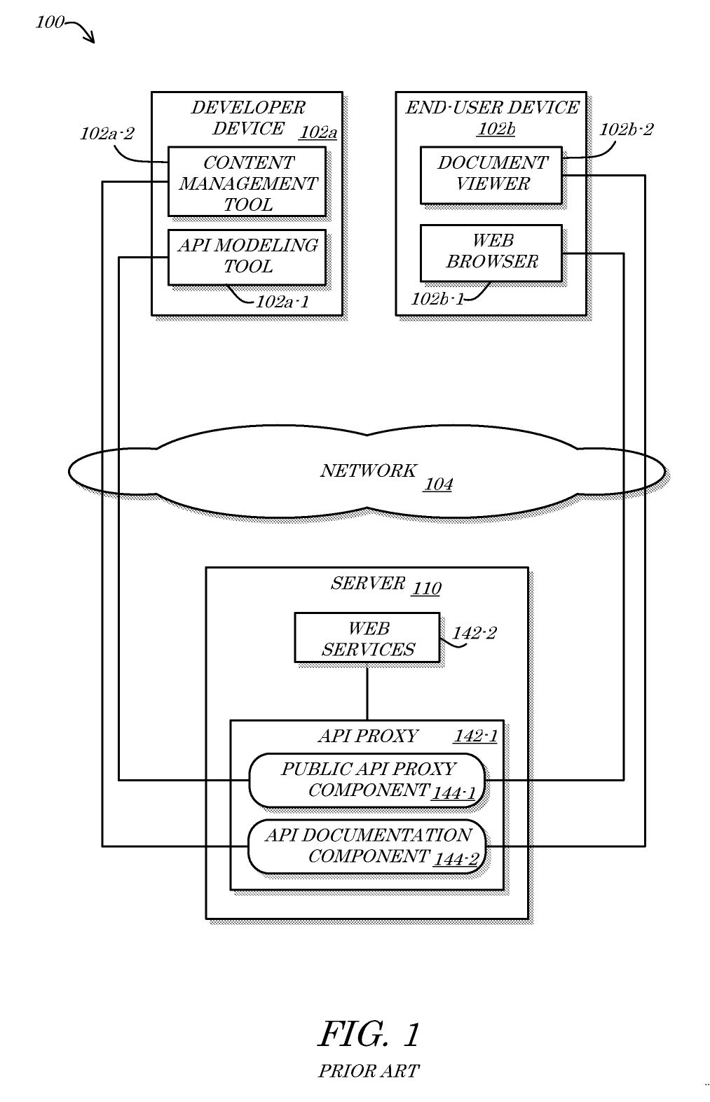

Referring to FIG. 1, for example, a prior art system 100 is shown. The prior art system 100 may comprise, for example, one or more user devices 102a-b (such as a developer device 102a and/or an end-user device 102b), a network 104, and/or a server 110. The server 110 may be in communication with the network 104 and/or one or more of the user devices 102a-b. In some cases, the developer device 102a may comprise an API modeling tool 102a-1 and/or a content management tool 102a-2. The API modeling tool 102a-1 may, for example, comprise a software language (e.g., eXtensible Markup Language (XML), Hyper-Text Transfer Protocol (HTTP), and/or RESTful API Modeling Language (RAML)) programming device and/or module such as a software language scripting, compiling, building, parsing, and/or management tool. In some cases, the developer device may comprise a content management tool 102a-2 such as a text editor and/or word processor device and/or module.

In some cases, the API modeling tool 102a-1 may be utilized to create an API model that is provided to the server 110. The API model may, for example, be published to an API proxy 142-1 available on the server 110. The API model may generally be published to the API proxy 142-1 as a public API proxy component 144-1. The public API proxy component 144-1 may, for example, be callable by a web browser 102b-1 of the end-user device 102b (e.g., via one or more HTTP API calls). The API proxy 142-1 may, in response to calls from the end-user device 102b, execute one or more actions as defined by the public API proxy component 144-1. The API proxy 142-1 may, for example, call and/or execute one or more web services 142-2 available via the server 110.

In typical situations, the content management tool 102a-2 is utilized to create API documentation which can be uploaded to the server 110 (and/or API proxy 142-1) as an API documentation component 144-2. The API documentation component 144-2 may be useful to end-users wishing to utilize the public API proxy component 144-1. The end-user device 102b may typically employ a document viewer 102b-2 to facilitate or enable viewing of the API documentation component 144-2 available on the server 110.

In contrast, and in accordance with novel embodiments described herein, a single source document (e.g., an API Web Application Description Language (WADL) or “YAML Ain't Markup Language” (YAML™) definition) may be utilized to both publish an API to a proxy and create API documentation made available for developers to use. According to some embodiments, this can all be done in a single step, greatly saving time and resources.

### II. Systems

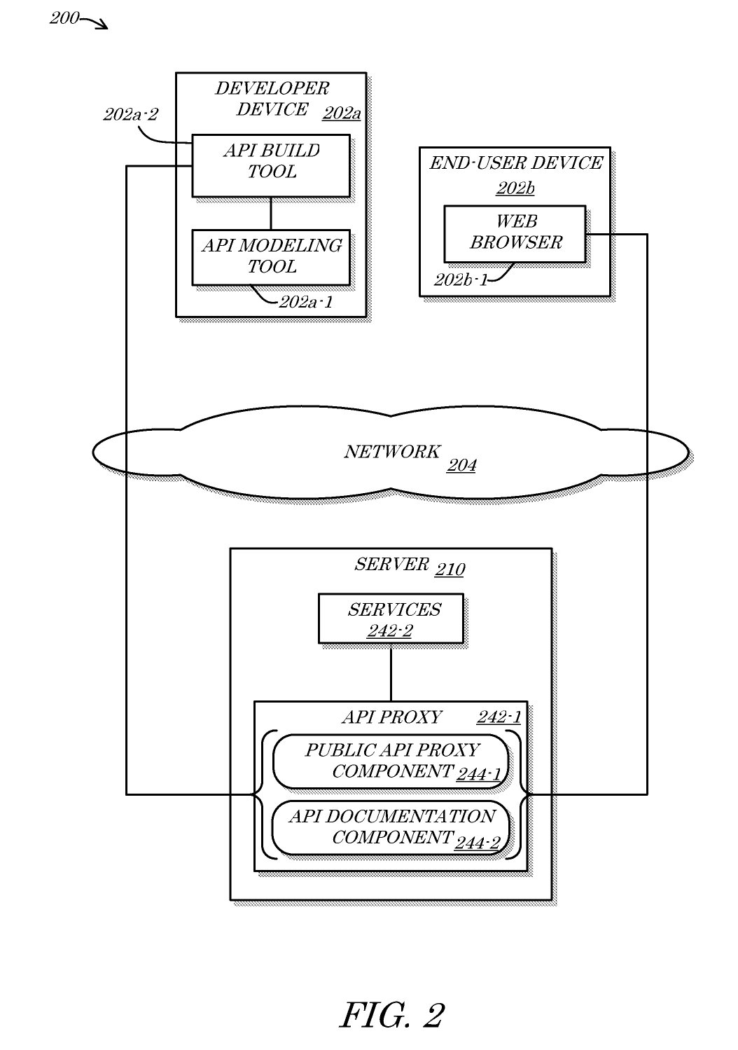

Turning to FIG. 2, for example, a system 200 according to some embodiments is shown. The system 200 may, for example, comprise a version of the system 100 of FIG. 1 that is modified in accordance with some embodiments. The system 200 may comprise, for example, one or more user devices 202a-b (e.g., a developer device 202a and/or an end-user device 202b), a network 204, and/or a server 210. In some embodiments, the developer device 202a (e.g., a first one of the user devices 202a-b) may comprise an API modeling tool 202a-1 and/or an API build tool 202a-2. According to some embodiments, the end-user device 202b (e.g., a second one of the user devices 202a-b) may comprise a web browser 202b-1. In some embodiments, the server 210 may comprise an API proxy 242-1 and/or one or more services 242-2. In some embodiments, the API proxy 242-1 may comprise a public API proxy component 244-1 and/or an API documentation component 244-2.

According to some embodiments, any or all of the components 202a-b, 202a-1, 202a-2, 202b-1, 204, 210, 242-1, 242-2, 244-1, 244-2 of the system 200 may be similar in configuration and/or functionality to any similarly named and/or numbered components described herein. Fewer or more components 202a-b, 202a-1, 202a-2, 202b-1, 204, 210, 242-1, 242-2, 244-1, 244-2 (and/or portions thereof) and/or various configurations of the components 202a-b, 202a-1, 202a-2, 202b-1, 204, 210, 242-1, 242-2, 244-1, 244-2 may be included in the system 200 without deviating from the scope of embodiments described herein. While multiple instances of some components 202a-b are depicted and while single instances of other components 202a-1, 202a-2, 202b-1, 204, 210, 242-1, 242-2, 244-1, 244-2 are depicted, for example, any component 202a-b, 202a-1, 202a-2, 202b-1, 204, 210, 242-1, 242-2, 244-1, 244-2 depicted in the system 200 may comprise a single device, a combination of devices and/or components 202a-b, 202a-1, 202a-2, 202b-1, 204, 210, 242-1, 242-2, 244-1, 244-2, and/or a plurality of devices, as is or becomes desirable and/or practicable. Similarly, in some embodiments, one or more of the various components 202a-b, 202a-1, 202a-2, 202b-1, 204, 210, 242-1, 242-2, 244-1, 244-2 may not be needed and/or desired in the system 200.

The user devices 202a-b, in some embodiments, may comprise any type or configuration of electronic, mobile electronic, and or other network and/or communication devices (or combinations thereof) that are or become known or practicable. The developer device 202a may, for example, comprise one or more PC devices, computer workstations, and/or tablet computers, such as an iPad® manufactured by Apple®, Inc. of Cupertino, Calif. In some embodiments, the end-user device 202b may comprise one or more PC devices, tablet computers, gaming consoles and/or client devices, and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, one or more of the user devices 202a-b may be specifically utilized and/or configured (e.g., via specially-programmed and/or stored instructions such as may define or comprise a software application) to communicate with the server 210 (e.g., via the network 204).

The network 204 may, according to some embodiments, comprise a LAN, WAN, cellular telephone network, Bluetooth® network, NFC network, and/or RF network with communication links between the user devices 202a-b and the server 210. In some embodiments, the network 204 may comprise direct communications links between any or all of the other components 202a-b, 202a-1, 202a-2, 202b-1, 210, 242-1, 242-2, 244-1, 244-2 of the system 200. The server 210 may, for example, be directly interfaced or connected to the developer device 202a via one or more wires, cables, wireless links, and/or other network components, such network components (e.g., communication links) comprising portions of the network 204. In some embodiments, the network 204 may comprise one or many other links or network components other than those depicted in FIG. 2. The end-user device 202b may, for example, be connected to the server 210 via various cell towers, routers, repeaters, ports, switches, and/or other network components that comprise the Internet and/or a cellular telephone (and/or Public Switched Telephone Network (PSTN)) network, and which comprise portions of the network 204.

While the network 204 is depicted in FIG. 2 as a single object, the network 204 may comprise any number, type, and/or configuration of networks that is or becomes known or practicable. According to some embodiments, the network 204 may comprise a conglomeration of different sub-networks and/or network components interconnected, directly or indirectly, by the other components 202a-b, 202a-1, 202a-2, 202b-1, 210, 242-1, 242-2, 244-1, 244-2 of the system 200. The network 204 may comprise one or more cellular telephone networks with communication links between the user devices 202a-b and the server 210, for example, and/or may comprise the Internet (and/or a portion thereof), with communication links between the user devices 202a-b and the server 210, for example.

According to some embodiments, the server 210 may comprise a device (and/or system) owned and/or operated by or on behalf of or for the benefit of a game provider (not explicitly shown). The game provider may utilize end-user (e.g., player or end-developer) and/or game information or instructions, in some embodiments, to host, manage, analyze, design, define, price, conduct, and/or otherwise provide (or cause to be provided) one or more games such as online multiplayer games (e.g., one or more games social, casual, and/or wagering games). In some embodiments, the game provider (and/or a third-party; not explicitly shown) may provide an interface (not shown in FIG. 2) to and/or via the web browser 202b-1 of the end-user device 202b. The interface may be configured, according to some embodiments, to allow and/or facilitate electronic game play by one or more players. In some embodiments, the system 200 (and/or interface provided by the server 210) may present game data in such a manner that allows players to participate in one or more online games (singularly, in/with groups, and/or otherwise). According to some embodiments, the server 210 may cause and/or facilitate play and/or development of one or more games via the API proxy 242-1 and/or the services 242-2.

In some embodiments for example, the API proxy 242-1 may store, define, and/or provide access to the public API proxy component 244-1, which itself is configured (e.g., specially-programmed) to accept incoming API calls (e.g., from the web browser 202b-1 and/or the end-user device 202b) and map, route, and/or otherwise process such incoming calls (e.g., inputs) to the services 242-2. The services 242-2 may, in response to the API proxy 242-1 and/or the public API proxy component 244-1, provide one or more responses, values, and/or other output that is directed to (e.g., transmitted to) the web browser 202b-1 and/or the end-user device 202b. In such a manner, for example, the web browser 202b-1 may implement various API definitions and/or models as defined by the public API proxy component 244-1 (e.g., in accordance with and/or to conduct or facilitate online game play and/or to conduct or facilitate game development utilizing the public API proxy component 244-1), such as to provide web services (e.g., the services 242-2) to the end-user device 202b (e.g., via the web browser 202b-1).

According to some embodiments, the public API proxy component 244-1 may be defined and/or built by and/or via the developer device 202a. A developer (not shown in FIG. 2) may utilize the developer device 202a and/or the API modeling tool 202a-1, for example, to prepare and/or generate an API model and/or definition. In some embodiment, the API modeling tool 202a-1 may comprise one or more software components configured to allow and/or facilitate programming via one or more particular programming languages and/or in accordance with one or more particular programming architectures. The API modeling tool 202a-1 may, for example, allow the developer to define and/or model the API in a REpresentational State Transfer (REST) architectural style and/or via a particular bespoke markup language and/or language specification such as YAML™ (e.g., in accordance with the YAML™ version 1.2 specification available at http://yaml.org/spec/1.2/spec.html).

In some embodiments, the API model (e.g., output from the API modeling tool 202a-1), such as in the form of a YAML™ file, may be provided to the API build tool 202a-2. The API build tool 202a-2 may, for example, comprise a project management tool such as Apache® Maven™ and/or an extension and/or plugin thereof. According to some embodiments, the API build tool 202a-2 may retrieve the API model/definition from a standardized location such as a network-accessible storage device (not shown in FIG. 2) and/or location thereof—such as a centralized developer project repository. In some embodiments, the API build tool 202a-2 may parse and/or otherwise process the API model/definition (e.g., in accordance with stored rules and/or specially-programmed instructions) to create and/or generate both the public API proxy component 244-1 and the API documentation component 244-2. The public API proxy component 244-1 may be generated as one or more proxy bundles such as an Apigee™ proxy bundle zip file containing a plurality of associated XML files and/or the API documentation component 244-2 may be generated as one or more Swagger™ formatted files and/or as a web-executable file such as a Java® ARchive (JAR) file. In some embodiments, the API build tool 202a-2 may also create and/or generate one or more source files (not explicitly shown in FIG. 2) that define at least one proxy endpoint. The source file may comprise, for example, a Java® source file defining proxy endpoints utilizing JAX-RS in accordance with the JAX-RS 2.0: The Java API for RESTful Web Services specification, published by the Oracle® corporation of Redwood City, Calif., and available at https://jcp.org/en/jsr/detail?id=339.

In such a manner, for example, the single API model/definition/file created on the developer device 202a-2 via the API modeling tool 202a-1 may be processed by the API build tool 202a-2 to automatically define both the public API proxy component 244-1 and the API documentation component 244-2. In the case that the API build tool 202a-2 resides on and/or is executed by the developer device 202a-2, the public API proxy component 244-1 and the API documentation component 244-2 may be transmitted to (and according received by) the server 210 (and/or the API proxy 242-1 thereof). In some embodiments, such as in the case that the API build tool 202a-2 resides on and/or is executed by the server 210 (not explicitly shown in FIG. 2, for ease of illustration), only the API model/definition/file from the API modeling tool 202a-1 may need to be transmitted to (and accordingly received by) the server 210.

In some embodiments, the end-user device 202b may then be utilized to send one or more API calls to the server 210 (and/or the API proxy 242-1 thereof), such as one or more HTTP calls generated by the web browser 202b-1. The API proxy 242-1 may process the received call(s) in accordance with the public API proxy component 244-1 generated by the API build tool 202a-2 (e.g., to access and/or utilize the services 242-2). The end-user device 202b may also or alternatively, in some embodiments, utilize the web browser 202b-1 to access the API documentation component 244-2. In such a manner, for example, an end-user would not need to utilize a secondary program (such as the document viewer 102b-2 of FIG. 1) to view the API documentation component 244-2, and the API documentation component 244-2, having been generated automatically in conjunction with the associated public API proxy component 244-1, will be properly synchronized with the associated public API proxy component 244-1.

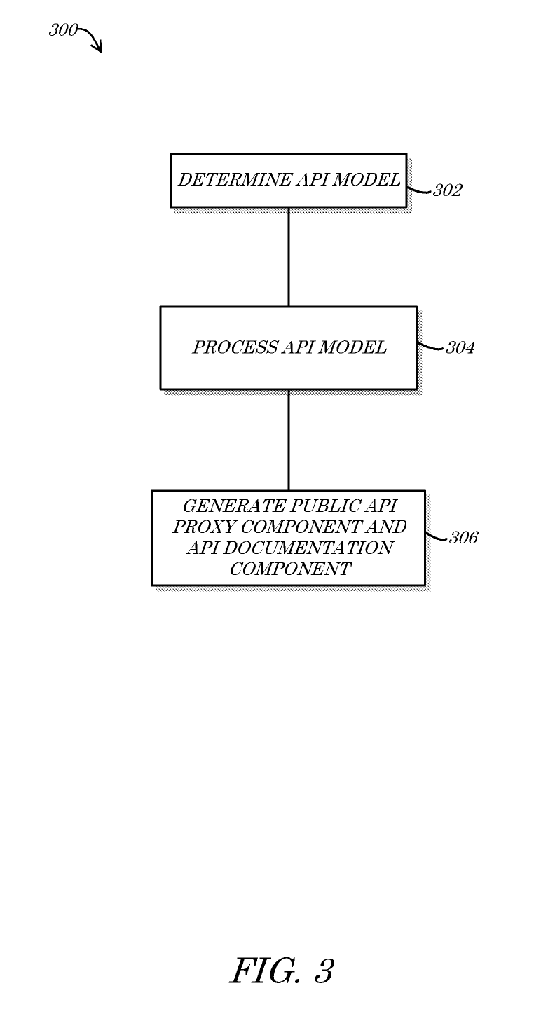

According to some embodiments, any or all of the user devices 202a-b and/or the server 210 (e.g., via the network 204) may conduct (in whole or in part), facilitate, and/or otherwise be associated with execution of one or more stored procedures, applications, processes, and/or methods (e.g., the method 300 of FIG. 3 herein, and/or one or more portions thereof) as described herein.

### III. Methods

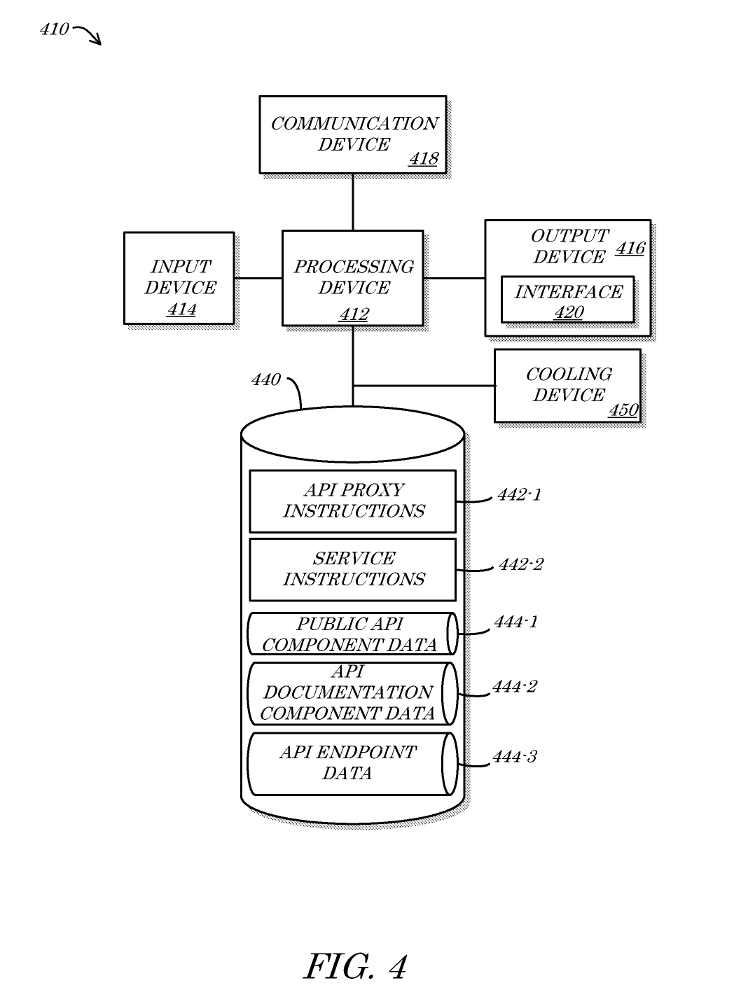

Referring now to FIG. 3 for example, a flow diagram of a method 300 according to some embodiments is shown. In some embodiments, the method 300 may be performed and/or implemented by and/or otherwise associated with one or more specialized and/or computerized processing devices (e.g., the user devices 202a-b and/or the server or apparatus 210, 410 of FIG. 2 and/or FIG. 4 herein), specialized computers, computer terminals, computer servers, computer systems and/or networks, and/or any combinations thereof (e.g., by one or more online game providers and/or online gaming processing devices). In some embodiments, the method 300 may be embodied in, facilitated by, and/or otherwise associated with various input mechanisms and/or interfaces.

The process and/or flow diagrams described herein do not necessarily imply a fixed order to any depicted actions, steps, and/or procedures, and embodiments may generally be performed in any order that is practicable unless otherwise and specifically noted. Any of the processes and/or methods described herein may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described herein.

In some embodiments, the method 300 may comprise determining (e.g., by a processing device and/or via an electronic communications network device) an API model, at 302. An API model, specification, and/or definition, such as resident and/or embodied in an electronic file (e.g., a WADL or YAML™ file) for example, may be received (e.g., from a developer device) and/or accessed (e.g., via a network-accessible storage device). As a non-limiting example, a YAML™ file defining an API model may read (at least in part):

----------------------------
# Limit Collection Resource
# ----------------------------
resource: “limits”
desc: “resource to represent a collection of all limit types”
methods:
- method: “GET”

```
desc: |
  performs a search across all limit types based upon accountId
  and/or limit type
responseType: “Array[LimitLink]”
parameters:
  - name: “accountId”
```

desc: |
account id to search for
required: true
type: “int”

.......

which may define, for example, a resource titled “limits”, that supports an HTTP “GET” method.

According to embodiments, the method 300 may comprise processing (e.g., by the processing device and/or via an electronic communications network device) the API model, at 304. Specially-programmed instructions and/or stored rules and/or logic may be invoked, for example, that utilize the API model determined at 302 to produce one or more outputs (e.g., output files and/or runtime artifacts). In some embodiments, the instructions may be embodied in an API build tool or module such as the API build tool 202a-2 of FIG. 2. According to some embodiments, the API model (e.g., a YAML™ file) may be parsed, analyzed, encoded, decoded, compressed, decompressed, transformed, and/or otherwise manipulated and/or processed as desired. The API model may, for example, be parsed and analyzed to automatically determine various attributes, functionality, purpose, structure, and/or other features of the API model.

In some embodiments, the method 300 may comprise generating (e.g., by the processing device and/or via an electronic communications network device) a public API proxy component and an API documentation component, at 306. The processing at 304 may result, for example, in the automatic output of various parameters and/or files representing the API model. The public API proxy component may, for example, comprise an API proxy definition published to and/or registered with one or more servers (such as the server 210). The API documentation component (e.g., which may be automatically derived, based on stored rules, from the API model via the processing at 304) may comprise various types of documentation files. The API documentation component may, for example, comprise one or more Swagger™ format files and/or one or more JAR files. In the case of a JAR file, the API documentation may be viewable via an executable operable to function within a web browser interface (e.g., an HTTP-compatible format).

According to some embodiments, the processing at 304 may also or alternatively result in a generation and/or creation of one or more endpoint source files. The API build tool may, for example, automatically create a Java® source file that utilizes JAX-RS annotations to define one or more endpoints for the API proxy component. In such a manner, for example (particularly in the case where each of the public API proxy component, API documentation, and endpoint source file are automatically created from the single API model file), development and distribution of API models (e.g., via an API proxy such as the API proxy 242-1 of FIG. 2) may be more efficiently, easily, and/or consistently effectuated.

### IV. Apparatus and Article of Manufacture

Turning to FIG. 4, a block diagram of an apparatus 410 according to some embodiments is shown. In some embodiments, the apparatus 410 may be similar in configuration and/or functionality to any of user devices 202a-b and/or the server or apparatus 210, 410 of FIG. 2 and/or FIG. 4 herein, and/or may otherwise comprise a portion of the system 200 of FIG. 2 herein. The apparatus 410 may, for example, execute, process, facilitate, and/or otherwise be associated with the method 300 of FIG. 3 herein, and/or one or more portions thereof. In some embodiments, the apparatus 410 may comprise a processing device 412, an input device 414, an output device 416, a communication device 418, an interface 420, a memory device 440 (storing various programs and/or instructions 442 and data 444), and/or a cooling device 450. According to some embodiments, any or all of the components 412, 414, 416, 418, 420, 440, 442, 444, 450 of the apparatus 410 may be similar in configuration and/or functionality to any similarly named and/or numbered components described herein. Fewer or more components 412, 414, 416, 418, 420, 440, 442, 444, 450 and/or various configurations of the components 412, 414, 416, 418, 420, 440, 442, 444, 450 be included in the apparatus 410 without deviating from the scope of embodiments described herein.

According to some embodiments, the processing device 412 may be or include any type, quantity, and/or configuration of electronic and/or computerized processor that is or becomes known. The processing device 412 may comprise, for example, an Intel® IXP 2800 network processor or an Intel® XEON™ Processor coupled with an Intel® E7501 chipset. In some embodiments, the processing device 412 may comprise multiple inter-connected processors, microprocessors, and/or micro-engines. According to some embodiments, the processing device 412 (and/or the apparatus 410 and/or portions thereof) may be supplied power via a power supply (not shown) such as a battery, an Alternating Current (AC) source, a Direct Current (DC) source, an AC/DC adapter, solar cells, and/or an inertial generator. In the case that the apparatus 410 comprises a server such as a blade server, necessary power may be supplied via a standard AC outlet, power strip, surge protector, a PDU, and/or Uninterruptible Power Supply (UPS) device.

In some embodiments, the input device 414 and/or the output device 416 are communicatively coupled to the processing device 412 (e.g., via wired and/or wireless connections and/or pathways) and they may generally comprise any types or configurations of input and output components and/or devices that are or become known, respectively. The input device 414 may comprise, for example, a keyboard that allows an operator of the apparatus 410 to interface with the apparatus 410 (e.g., by a player, such as to participate in a game associated with an API proxy having automatically generated documentation, as described herein). In some embodiments, the input device 414 may comprise a sensor configured to provide information such as player input to the apparatus 410 and/or the processing device 412. The output device 416 may, according to some embodiments, comprise a display screen and/or other practicable output component and/or device. The output device 416 may, for example, provide the interface 420 to an end-user (e.g., via a website and/or electronic communications network device). According to some embodiments, the input device 414 and/or the output device 416 may comprise and/or be embodied in a single device such as a touch-screen monitor (e.g., a device capable of both receiving input and providing output).

In some embodiments, the communication device 418 may comprise any type or configuration of communication device that is or becomes known or practicable. The communication device 418 may, for example, comprise a network interface card (NIC), a telephonic device, a cellular network device, a router, a hub, a modem, and/or a communications port or cable. In some embodiments, the communication device 418 may be coupled to provide data to a user device (not shown in FIG. 4), such as in the case that the apparatus 410 is utilized to provide the interface 420 to a player and/or end-user as described herein. The communication device 418 may, for example, comprise a cellular telephone network transmission device that sends signals indicative of game interface components to customer and/or subscriber handheld, mobile, and/or telephone device. According to some embodiments, the communication device 418 may also or alternatively be coupled to the processing device 412. In some embodiments, the communication device 418 may comprise an IR, RF, Bluetooth™, NFC, and/or Wi-Fi® network device coupled to facilitate communications between the processing device 412 and another device (such as a player device and/or a third-party device).

The memory device 440 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 440 may, according to some embodiments, store one or more of API proxy instructions 442-1 and/or services instructions 442-2. In some embodiments, the API proxy instructions 442-1 and/or services instructions 442-2 may be utilized by the processing device 412 to provide output information via the output device 416 and/or the communication device 418.

According to some embodiments, the API proxy instructions 442-1 may be operable to cause the processing device 412 to process public API component data 444-1, API documentation component data 444-2, and/or API endpoint data 444-3. Public API component data 444-1, API documentation component data 444-2, and/or API endpoint data 444-3 received via the input device 414 and/or the communication device 418 may, for example, be analyzed, sorted, filtered, decoded, decompressed, ranked, scored, plotted, and/or otherwise processed by the processing device 412 in accordance with the API proxy instructions 442-1. In some embodiments, public API component data 444-1, API documentation component data 444-2, and/or API endpoint data 444-3 may be fed by the processing device 412 through one or more mathematical and/or statistical formulas and/or models in accordance with the API proxy instructions 442-1 to provide API proxy and/or API documentation services in accordance with embodiments described herein.

In some embodiments, the services instructions 442-2 may be operable to cause the processing device 412 to process public API component data 444-1, API documentation component data 444-2, and/or API endpoint data 444-3. Public API component data 444-1, API documentation component data 444-2, and/or API endpoint data 444-3 received via the input device 414 and/or the communication device 418 may, for example, be analyzed, sorted, filtered, decoded, decompressed, ranked, scored, plotted, and/or otherwise processed by the processing device 412 in accordance with the services instructions 442-2. In some embodiments, public API component data 444-1, API documentation component data 444-2, and/or API endpoint data 444-3 may be fed by the processing device 412 through one or more mathematical and/or statistical formulas and/or models in accordance with the services instructions 442-2 to provide the interface 420 which may comprise, for example, one or more game interfaces configured to (e.g., specially-programmed to) provide wagering and/or wager-style games in accordance with one or more API models provided via an API proxy in accordance with embodiments described herein.

Any or all of the exemplary instructions and data types described herein and other practicable types of data may be stored in any number, type, and/or configuration of memory devices that is or becomes known. The memory device 440 may, for example, comprise one or more data tables or files, databases, table spaces, registers, and/or other storage structures. In some embodiments, multiple databases and/or storage structures (and/or multiple memory devices 440) may be utilized to store information associated with the apparatus 410. According to some embodiments, the memory device 840 may be incorporated into and/or otherwise coupled to the apparatus 410 (e.g., as shown) or may simply be accessible to the apparatus 410 (e.g., externally located and/or situated).

In some embodiments, the apparatus 410 may comprise the cooling device 450. According to some embodiments, the cooling device 450 may be coupled (physically, thermally, and/or electrically) to the processing device 412 and/or to the memory device 440. The cooling device 450 may, for example, comprise a fan, heat sink, heat pipe, radiator, cold plate, and/or other cooling component or device or combinations thereof, configured to remove heat from portions or components of the apparatus 410.

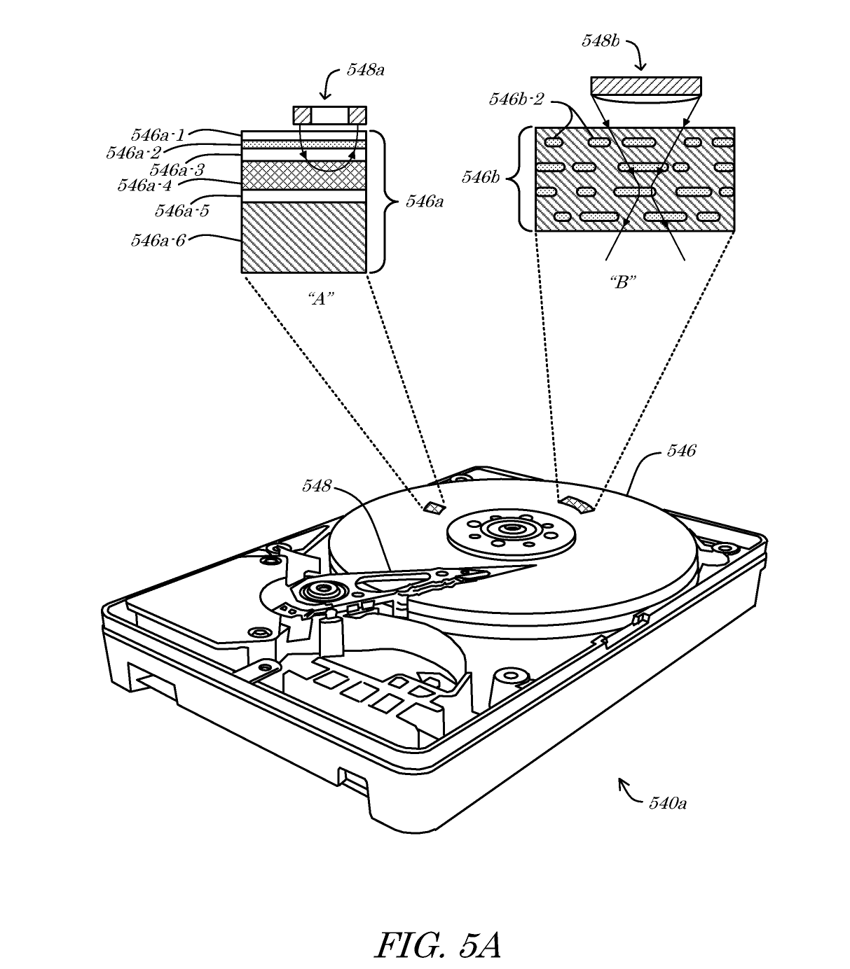

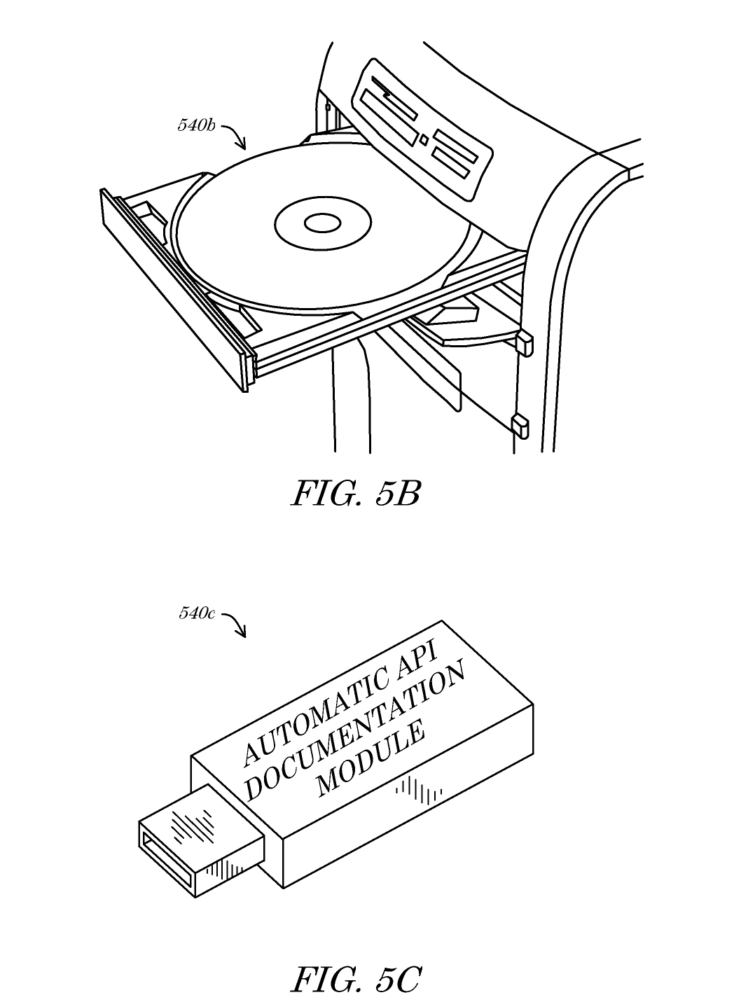

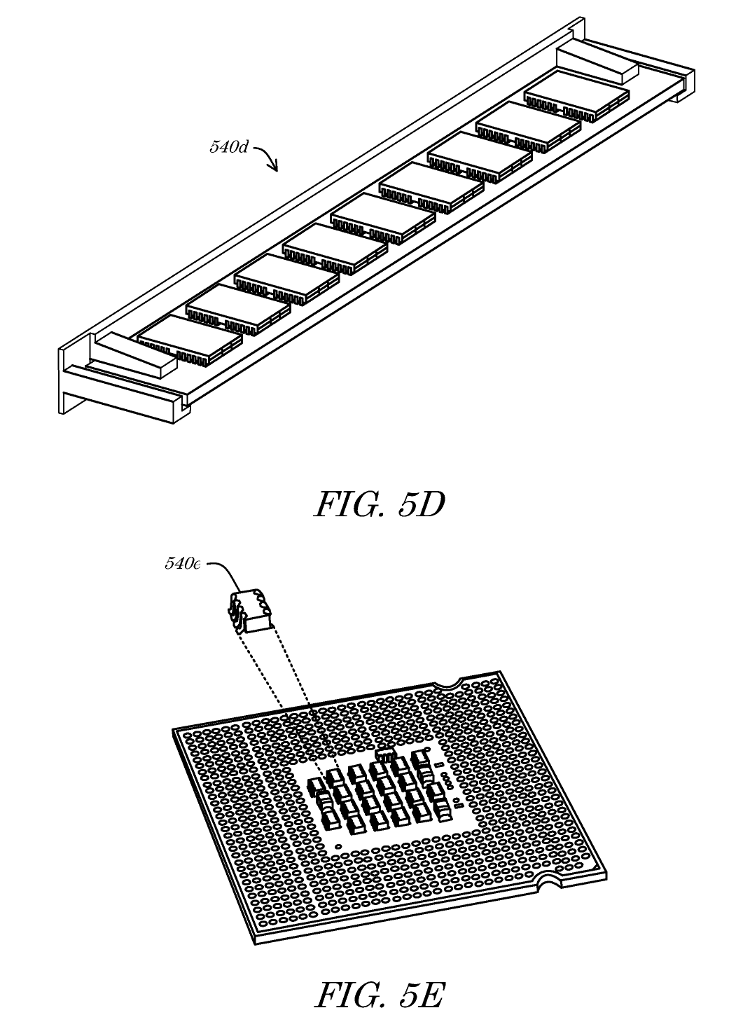

Referring now to FIG. 5A, FIG. 5B, FIG. 5C, FIG. 5D, and FIG. 5E, perspective diagrams of exemplary data storage devices 540a-e according to some embodiments are shown. The data storage devices 540a-e may, for example, be utilized to store instructions and/or data such as the API proxy instructions 442-1, services instructions 442-2, public API component data 444-1, API documentation component data 444-2, and/or API endpoint data 444-3, each of which is described in reference to FIG. 4 herein. In some embodiments, instructions stored on the data storage devices 540a-e may, when executed by a processor, cause the implementation of and/or facilitate the method 300 of FIG. 3 and/or portions thereof described herein.

According to some embodiments, the first data storage device 540a may comprise one or more various types of internal and/or external hard drives. The first data storage device 540a may, for example, comprise a data storage medium 546 that is read, interrogated, and/or otherwise communicatively coupled to and/or via a disk reading device 548. In some embodiments, the first data storage device 540a and/or the data storage medium 546 may be configured to store information utilizing one or more magnetic, inductive, and/or optical means (e.g., magnetic, inductive, and/or optical-encoding). The data storage medium 546, depicted as a first data storage medium 546a for example (e.g., breakout cross-section “A”), may comprise one or more of a polymer layer 546a-1, a magnetic data storage layer 546a-2, a non-magnetic layer 546a-3, a magnetic base layer 546a-4, a contact layer 546a-5, and/or a substrate layer 546a-6. According to some embodiments, a magnetic read head 546a may be coupled and/or disposed to read data from the magnetic data storage layer 546a-2.

In some embodiments, the data storage medium 546, depicted as a second data storage medium 546b for example (e.g., breakout cross-section “B”), may comprise a plurality of data points 546b-2 disposed with the second data storage medium 546b. The data points 546b-2 may, in some embodiments, be read and/or otherwise interfaced with via a laser-enabled read head 548b disposed and/or coupled to direct a laser beam through the second data storage medium 546b.

In some embodiments, the second data storage device 540b may comprise a CD, CD-ROM, DVD, Blu-Ray™ Disc, and/or other type of optically-encoded disk and/or other storage medium that is or becomes known or practicable. In some embodiments, the third data storage device 540c may comprise a USB keyfob, dongle, and/or other type of flash memory data storage device that is or becomes know or practicable. In some embodiments, the fourth data storage device 540d may comprise RAM of any type, quantity, and/or configuration that is or becomes practicable and/or desirable. In some embodiments, the fourth data storage device 540d may comprise an off-chip cache such as a Level 2 (L2) cache memory device. According to some embodiments, the fifth data storage device 540e may comprise an on-chip memory device such as a Level 1 (L1) cache memory device.

The data storage devices 540a-e may generally store program instructions, code, and/or modules that, when executed by a processing device cause a particular machine to function in accordance with one or more embodiments described herein. The data storage devices 540a-e depicted in FIG. 5A, FIG. 5B, FIG. 5C, FIG. 5D, and FIG. 5E are representative of a class and/or subset of computer-readable media that are defined herein as “computer-readable memory” (e.g., non-transitory memory devices as opposed to transmission devices or media).

The terms “computer-readable medium” and “computer-readable memory” refer to any medium that participates in providing data (e.g., instructions) that may be read by a computer and/or a processor. Such a medium may take many forms, including but not limited to non-volatile media, volatile media, and other specific types of transmission media. Non-volatile media include, for example, optical or magnetic disks and other persistent memory. Volatile media include DRAM, which typically constitutes the main memory. Other types of transmission media include coaxial cables, copper wire, and fiber optics, including the wires that comprise a system bus coupled to the processor.

Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable medium” and/or “tangible media” specifically exclude signals, waves, and wave forms or other intangible or transitory media that may nevertheless be readable by a computer.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined above and includes many exemplary protocols that are also applicable here.

In some embodiments, one or more specialized machines such as a computerized processing device, a server, a remote terminal, and/or a customer or user device may implement the various practices described herein. A computer system of an game provider may, for example, comprise various specialized computers that interact to provide for games conducted in accordance with API models (e.g., automatically-documented API models) as described herein.

### V. Terms and Definitions

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting. While not generally limiting and while not limiting for all described embodiments, in some embodiments, the terms are specifically limited to the example definitions and/or examples provided. Other terms are defined generally throughout the present description.

A “game”, as the term is utilized herein (unless otherwise specified), may generally comprise any game (e.g., wagering or non-wagering, skill-based, chance-based, playable by hand (e.g., utilizing non-electric physical components, boards, and/or pieces), and/or electronically playable over a network) playable by one or more players in accordance with specified rules. An electronic game may be playable on a Personal Computer (PC), online in web browsers, on a game console, and/or on a mobile device such as a smart-phone or tablet computer. “Gaming” thus generally refers to play of a game (e.g., by one or more players).

A “wager-style game”, as the term is utilized herein (unless otherwise specified), generally refers to a game that is played in the same manner as a wagering game, but does not technically qualify as gambling. Casual and/or social network games may, for example, be conducted in the same manner of game play as a wagering game such as slots, but may not accept true wagers from players and/or may otherwise differ from true wagering games.

A “casual game”, as the term is utilized herein (unless otherwise specified), may generally comprise a game with simple rules with little or no time commitment on the time of a player to play. A casual game may feature, for example, very simple game play such as a puzzle or Scrabble™ game, may allow for short bursts of play (e.g., during work breaks), an ability to quickly reach a final stage and/or continuous play without a need to save the game.

A “social network game”, as utilized herein (unless otherwise specified), generally refers to a type of online game that is played through a social network, and in some embodiments may feature multiplayer and/or asynchronous game play mechanics. A “social network” may refer to an online service, online community, platform, and/or site that focuses on facilitating the building of social networks or social relations among people. A social network service may, for example, consist of a representation of each user (often a profile), his/her social links, and a variety of additional services. A social network may be web-based and provide means for users to interact over the Internet, such as e-mail and instant messaging. A social network game may in some embodiments be implemented as a web browser and/or web-client game, a Flash®, or Java®-scripted game, and/or may be implemented on one or more mobile platforms such as on portable electronic devices.

A “wagering game”, as the term is utilized herein (unless otherwise specified), may generally comprise a game in which a player can risk a wager or other consideration, such as, but not limited to: slot-style games, poker games, blackjack, baccarat, craps, roulette, lottery, bingo, keno, casino war, etc. A wager may comprise a monetary wager in the form of an amount of currency or any other tangible or intangible article having some value which may be risked on an outcome of a wagering game. “Gambling” or “wagering” generally refers to play of a wagering game.

The term “game provider”, as utilized herein (unless otherwise specified), generally refers to an entity or system of components which provides games for play and facilitates play of such game by use of a network such as the Internet or a proprietary or closed networks (e.g., an intranet or local or wide area network). For example, a game provider may operate a website which provides games in a digital format over the Internet. In some embodiments in which a game comprising a wagering game is provided, a game provider may operate a gambling website over which wagers are accepted and results (e.g., winnings) of wagering games are provided.

As utilized herein, the term “player” may generally refer to any type, quantity, and or manner of entity associated with the play of a game. In some embodiments, a player may comprise an entity conducting play of an online game, for example, may comprise an entity that desires to play a game (e.g., an entity registered and/or scheduled to play and/or an entity having expressed interest in the play of the game—e.g., a spectator) and/or may comprise an entity that configures, manages, and/or conducts a game. A player may be currently playing a game or have previously played the game, or may not yet have initiated play—i.e., a “player” may comprise a “potential player” (e.g., in general and/or with respect to a specific game). In some embodiments, a player may comprise a user of an interface (e.g., whether or not such a player participates in a game or seeks to participate in the game). In some embodiments, a player may comprise an individual (or group) that enters, joins, logs into, registers for, and/or otherwise access an online game room, session, server, and/or other particular instance and/or segmentation of an online game.

Some embodiments described herein are associated with a “user device”, “player device”, “developer device”, or a “network device”. As utilized herein, “player devices”, “user devices”, and “developer devices” are one or more subsets of a “network device”. The “network device”, for example, may generally refer to any device that can communicate via a network, while the “player device” may comprise a network device that is owned and/or operated by or otherwise associated with a player (e.g., a network device specifically configured to permit use thereof by the player, such as by receiving login credentials from the player). Examples of player, user, developer, and/or network devices may include, but are not limited to: a PC, a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. Player and/or network devices may, in some embodiments, comprise one or more network components. In some embodiments, a player device may comprise an electronic device configured to initiate, conduct, facilitate, and/or otherwise permit player participation in an electronic game.

As utilized herein, the term “network component” may refer to a player or network device, or a component, piece, portion, or combination of player or network devices. Examples of network components may include a Static Random Access Memory (SRAM) device or module, a network processor, and a network communication path, connection, port, or cable.

In addition, some embodiments are associated with a “network” or a “communication network.” As utilized herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration or type that is or becomes known. Communication networks may include, for example, devices that communicate directly or indirectly, via a wired or wireless medium such as the Internet, intranet, a Local Area Network (LAN), a Wide Area Network (WAN), a cellular telephone network, a Bluetooth® network, a Near-Field Communication (NFC) network, a Radio Frequency (RF) network, a Virtual Private Network (VPN), Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), and/or system to system (S2S).

As utilized herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard. Information may, according to some embodiments, be compressed, encoded, encrypted, and/or otherwise packaged or manipulated in accordance with any method that is or becomes known or practicable.

The term “indication”, as utilized herein (unless otherwise specified), may generally refer to any indicia and/or other information indicative of or associated with a subject, item, entity, and/or other object and/or idea. As utilized herein, the phrases “information indicative of” and” indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

A “session”, as the term is utilized herein (unless otherwise specified), may generally comprise a period of time spanning a plurality of event instances (e.g., with respect to a communication and/or game session) or turns of a game, the session having a defined start and defined end. An event instance or turn is triggered upon an initiation of, or request for, at least one result of the game by a player, such as an actuation of a “start” or “spin” mechanism, which initiation causes an outcome to be determined or generated (e.g., an RNG is contacted or communicated with to identify, generate or determine a random number to be used to determine an outcome for the event instance).

As utilized herein, the terms “outcome” and “result” should be differentiated in the present description in that an “outcome” is generally a representation of a “result”, typically comprising one or more game elements or game symbols. For example, in a “fruit themed” slot-style game, a winning outcome (i.e., an outcome corresponding to some kind of award, prize or payout) may comprise a combination of three “cherry” symbols. The “result” of this outcome may be a payout of X credits awarded to the player associated with the game. In another example, in a game in which a character moves along a game interface from a starting position to a finish position, an “outcome” of the game may comprise a symbol representing one or more movements along the interface and the “result” corresponding to this outcome may be the particular number and direction of the character's movement (e.g., three (3) spaces backwards such that the character ends up further away from the finish line). In a session embodiment, a session result may comprise a binary result (e.g., a player or game character wins or loses the session) and/or the particular award (or magnitude of award) won or earned by the player based on the session (e.g., the number of credits awarded to the player). It should be noted that the embodiments described herein encompass awards, prizes and payouts which are monetary, non-monetary, tangible or intangible.

As utilized herein, the term “virtual currency” may generally refer to an in-game currency that may be utilized as part of a game or one or more games provided by a game provider as (i) currency for making wagers, and/or (ii) to purchase or access various in-game items, features or powers (e.g., “freemium” upgrades and/or options).

A “credit balance”, as the term is utilized herein (unless otherwise specified), may generally refer to (i) a balance of currency, whether virtual currency and/or real currency, usable for making wagers and/or purchases in a game and/or (ii) another tracking mechanism for tracking a player's success or advancement in a game by deducting there from points or value for unsuccessful attempts at advancement and adding thereto points or value for successful attempts at advancement.

Some embodiments are descriptive of an “array” or “matrix” of symbols or game outcomes. As utilized herein, the terms “array” and “matrix” generally refer to a group of symbols, numbers, and/or expressions arranged in a plurality of rows and columns (or that can be readily and appropriately represented mathematically as being so arranged). In some embodiments, the term “array” is utilized to refer to a multi-dimensional matrix or combination of matrices while the term “matrix” is utilized to refer to a two-dimensional set of symbols or numbers (e.g., slot reel symbols and/or mathematical representations thereof). According to some embodiments, such as in the case that an array and/or matrix is populated with graphical game symbols, the array or matrix may be output and/or displayed (e.g., transmit to and/or rendered on a player device) as part of a game session.

### VI. Rules of Interpretation

Numerous embodiments are described in this patent application, and are presented for illustrative purposes only. The described embodiments are not, and are not intended to be, limiting. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments. It is contemplated, however, that while some embodiment are not limited by the examples provided herein, some embodiments may be specifically bounded or limited by provided examples, structures, method steps, and/or sequences. Embodiments having scopes limited by provided examples may also specifically exclude features not explicitly described or contemplated.

Neither the Title (set forth at the beginning of the first page of this patent application) nor the Abstract (set forth at the end of this patent application) is to be taken as limiting in any way the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise. Similarly, any reference to an “alternate”, “alternative”, and/or “alternate embodiment” is intended to connote one or more possible variations—not mutual exclusivity. In other words, it is expressly contemplated that “alternatives” described herein may be utilized and/or implemented together, unless they inherently are incapable of being utilized together.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including the specification, its claims and figures, and anything which may be incorporated by reference, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”. In some embodiments, a first thing being “based on” a second thing refers specifically to the first thing taking into account the second thing in an explicit manner. In such embodiments, for example, a processing step based on the local weather, which itself is in some manner based on or affected by (for example) human activity in the rainforests, is not “based on” such human activities because it is not those activities that being explicitly analyzed, included, taken into account, and/or processed.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “wherein”, as utilized herein, does not evidence intended use. The term “wherein” expressly refers to one or more features inclusive in a particular embodiment and does not imply or include an optional or conditional limitation.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to allow for distinguishing that particular referenced feature from another feature that is described by the same term or by a similar term. For example, a “first widget” may be so named merely to allow for distinguishing it in one or more claims from a “second widget”, so as to encompass embodiments in which (1) the “first widget” is or is the same as the “second widget” and (2) the “first widget” is different than or is not identical to the “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; (3) does not indicate that either widget ranks above or below any other, as in importance or quality; and (4) does not indicate that the two referenced widgets are not identical or the same widget. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein. According to some embodiments, a “processor” may primarily comprise and/or be limited to a specific class of processors referred to herein as “processing devices”. “Processing devices” are a subset of processors limited to physical devices such as CPU devices, Printed Circuit Board (PCB) devices, transistors, capacitors, logic gates, etc. “Processing devices”, for example, explicitly exclude biological, software-only, and/or biological or software-centric physical devices. While processing devices may include some degree of soft logic and/or programming, for example, such devices must include a predominant degree of physical structure in accordance with 35 U.S.C. §101.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
determining, by a processing device, data defining an API model;
processing, by the processing device, the data defining the API model, wherein the processing results in a definition of (i) a public API proxy component and (ii) an API documentation component;
providing, by the processing device and to a user device, the API documentation component; and
providing access, by the processing device and to the user device, to the public API proxy component.

2. The method of claim 1, wherein the determining comprises:
receiving, by the processing device and from at least one of (i) an API modeling program and (ii) a developer device, an indication of the data defining the API model.

3. The method of claim 1, wherein the determining comprises:
reading, by the processing device and from a network-accessible data storage location, the data defining the API model.

4. The method of claim 1, wherein the data defining the API model is structured in accordance with a RESTful programming architecture.

5. The method of claim 1, wherein the data defining the API model is formatted in a bespoke markup language.

6. The method of claim 5, wherein the bespoke markup language comprises a YAML-based language.

7. The method of claim 1, wherein the processing is conducted by an API build tool.

8. The method of claim 7, wherein the processing is conducted by an extension to the API build tool.

9. The method of claim 1, wherein the processing comprises parsing the data defining the API model.

10. The method of claim 1, wherein the processing further results in a definition of (iii) a source file that defines a proxy endpoint.

11. The method of claim 1, wherein the API public proxy component comprises an API proxy bundle zip file.

12. The method of claim 1, wherein the API public proxy component defines an associated web service executable as part of an online gaming application.

13. The method of claim 1, wherein the API documentation component comprises an executable file.

14. The method of claim 1, further comprising:
receiving, by the processing device and from the user device, an API call;
processing, by the processing device and in accordance with the public API proxy component, the API call; and
providing, by the processing device and to the user device, output defined by the processing.

15. The method of claim 14, wherein the user device comprises a remote client device and wherein the API call comprise an HTTP request.

16. The method of claim 15, wherein the HTTP request comprise a request generated from a remote gaming application.

17. A system, comprising:
a processing device; and
a memory device in communication with the processing device, the memory device storing instructions that when executed by the processing device result in:
determining data defining an API model;
processing the data defining the API model, wherein the processing results in a definition of (i) a public API proxy component and (ii) an API documentation component;
providing, to a user device, the API documentation component; and
providing access, to the user device, to the public API proxy component.

18. The system of claim 17, wherein the processing comprises parsing the data defining the API model.

19. A non-transitory computer-readable memory storing instructions that when executed by a processing device result in:
determining data defining an API model;
processing the data defining the API model, wherein the processing results in a definition of (i) a public API proxy component and (ii) an API documentation component;
providing, to a user device, the API documentation component; and
providing access, to the user device, to the public API proxy component.

20. The non-transitory computer-readable memory of claim 19, wherein the processing comprises parsing the data defining the API model.
